(19) United States
(12) Patent Application Publication
(10) Pub. No.: US 2009/0300019 A1
(43) Pub. Date: Dec. 3, 2009

(54) HIERARCHICAL ITEM LEVEL ENTITLEMENT

(75) Inventors: Ilya Simon Itkin, Houston, TX (US); Subramoniapillay Vallinayagam Subramonian, Waterloo (CA); Dale Marvin Blue, Winterthur (CH); Stephen Chelack, Calgary (CA)

Correspondence Address: SCHLUMBERGER INFORMATION SOLUTIONS, 5599 SAN FELIPE, SUITE 1700, HOUSTON, TX, 77056-2722, US

(73) Assignee: Schumberger Technology Corporation, Houston, TX (US)

(21) Appl. No.: 12/426,344

(22) Filed: Apr. 20, 2009

Related U.S. Application Data
(60) Provisional application No. 61/057,728, filed on May 30, 2008.

(51) Int. Cl. G06F 12/14; G06F 17/30

(52) U.S. Cl. 707/9; 707/E17.009; 707/E17.014; 707/3

(57) ABSTRACT

A method for retrieving data from a database. The method includes receiving a query for the data in the database, determining a user associated with the query, and obtaining an entitlement entry associated with the user, the entitlement entry created by applying an entitlement rule associated with the user to a chasing rule. The method further includes determining, using a processor, an entitlement predicate for a data view query using the entitlement entry, the data view query including the entitlement predicate and associated with the query. The method further includes executing, on the processor, the data view query to obtain the data in the database, the user being entitled to view the data presenting the data to the user.

### CROSS-REFERENCE TO RELATED APPLICATION

This application claims priority, pursuant to 35 U.S.C. §119(e), to the filing date of U.S. patent application Ser. No. 61/057,728, entitled “Method and System for Hierarchical Item Level Entitlement,” filed on May 30, 2008, which is hereby incorporated by reference in its entirety.

### BACKGROUND

A database stores a collection of data. The data is typically stored in various tables, which are organized and related using an organization scheme. For example, if the database is a relational database, then a schema is used to define the tables, the fields in each table, and the relationships between fields and tables. A database includes functionality (typically implemented using a database management system) to allow multiple users to access the data stored in the database. However, in many cases, a given user is not permitted to access all the data within the database. Rather, the user is only allowed to access a subset of the data within the database. Conventionally, to enforce a given user's access permission to data within the database, the necessary access permissions are appended to the tables (or data within the tables). The database management system then uses the aforementioned access permissions to enforce a given user's access to the data within the database.

### SUMMARY

A method for retrieving data from a database. The method includes receiving a query for the data in the database, determining a user associated with the query, and obtaining an entitlement entry associated with the user, the entitlement entry created by applying an entitlement rule associated with the user to a chasing rule. The method further includes determining, using a processor, an entitlement predicate for a data view query using the entitlement entry, the data view query including the entitlement predicate and associated with the query. The method further includes executing, on the processor, the data view query to obtain the data in the database, the user being entitled to view the data presenting the data to the user.

Other aspects of hierarchical item level entitlement will be apparent from the following description and the appended claims.

### BRIEF DESCRIPTION OF DRAWINGS

FIG. 1 shows a system in accordance with one or more embodiments of hierarchical item level entitlement.

FIGS. 2-3 show methods in accordance with one or more embodiments of hierarchical item level entitlement.

FIG. 4 shows a computer system in accordance with one or more embodiments of hierarchical item level entitlement.

### DETAILED DESCRIPTION

Specific embodiments of hierarchical item level entitlement will now be described in detail with reference to the accompanying figures. Like elements in the various figures are denoted by like reference numerals for consistency.

In the following detailed description of embodiments of hierarchical item level entitlement, numerous specific details are set forth in order to provide a more thorough understanding of the embodiments. However, it will be apparent to one of ordinary skill in the art that the embodiments may be practiced without these specific details. In other instances, well-known features have not been described in detail to avoid unnecessarily complicating the description.

In general, the embodiments relates to a method and system for accessing data in a database. More specifically, embodiments of hierarchical item level entitlement relate to a method and system for enforcing fine-grained access to data within the database.

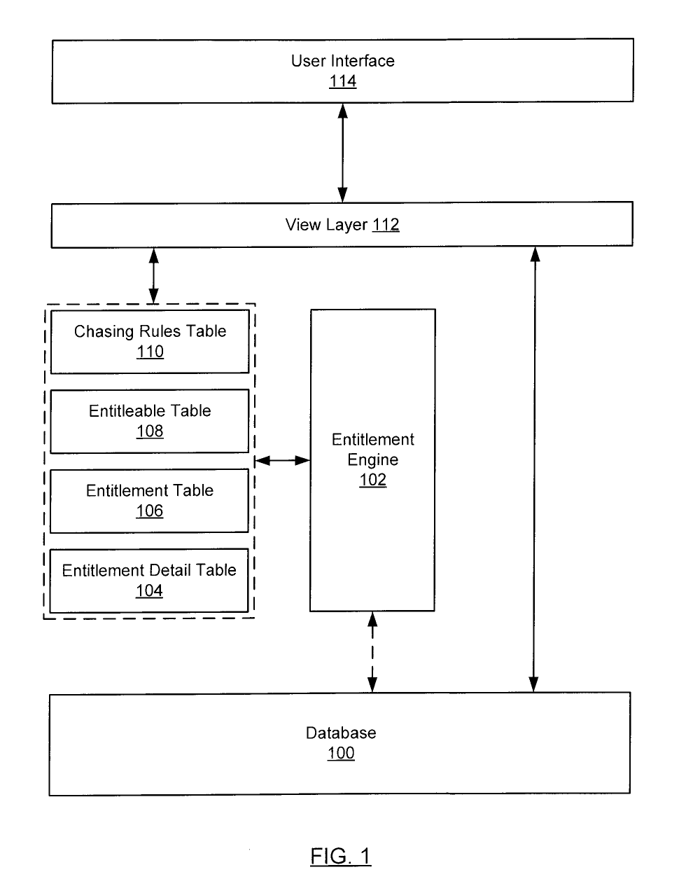

FIG. 1 shows a system in accordance with one or more embodiments of hierarchical item level entitlement. In one or more embodiments, the database (100) includes data stored in one or more tables. The data may include oilfield data such as data related to fields, wells, boreholes, etc. However, those skilled in the art will appreciate that the database (100) may store any type of data. In one or more embodiments, the tables within the database are organized in a hierarchy using a logical data model. The logical data model defines how each table in the database is associated with at least one other table in the database.

In one or more embodiments, the database (100) includes functionality to receive queries from a view layer (112), execute the queries, and the return the results of the query to the view layer (112). In one or more embodiments, the database (100) may be configured to receive and execute queries using a structured query language originating from a variety of software applications.

In one or more embodiments, the view layer (112) provides a layer of abstraction between a user interface (114) and the database (100). More specifically, the view layer (112) may be configured to create and manage data views, where a data view includes data specified in a data view query of one or more tables in the database. Further, the view layer (112) includes functionality to enforce access control to the data within the database (100). For example, the view layer (112) may be configured to reference a stored procedure in the data view query of a data view, where the stored procedure modifies the data view query to enforce access control to the data. In one or more embodiments, the view layer (112) includes functionality to receive queries from the user interface (114), determine an entitlement predicate to use in a data view query, send the data view query to the database to be executed, receive the result of executing the data view query from the database, and present the result to the user via the user interface (114).

In one or more embodiments, the view layer (112) determines the entitlement predicate(s) to use in the data view query using an Entitlement Detail table (104). In one or more embodiments, the Entitlement Detail table (104) is populated using an entitlement engine (102). The entitlement engine (102) is configured to obtain data from the Chasing Rules table (110), the Entitleable table (108), and the Entitlement table (106) and use the aforementioned data to generate one or more entries in the Entitlement Detail table (104).

In one or more embodiments, the Chasing Rules table (110) includes one or more chasing rules. Each chasing rule defines how to traverse tables within the database. More specifically, each chasing rule defines a source table (i.e., one of the tables in the database), a target table (i.e., another one of the tables in the database), and how to traverse the hierarchy of tables from the source table to the target table. For example, a set of chasing rules may be associated with a workflow, where the chasing rules define how to traverse the hierarchy of tables to obtain data for the workflow. In this example, the chasing rules may be based on entity relationships between tables in the database (e.g., one-to-one relationship, one-to-many relationship, many-to-many relationship, etc.), where entities in the workflow are retrieved based on the entity relationships.

Those skilled in the art will appreciate that chasing rules may be defined with increasing or decreasing granularity within a hierarchy. For example, a chasing rule may be defined from a subordinate entity to a superior entity of the hierarchy (i.e., decreasing granularity). In another example, a chasing rule may be defined from a superior entity to a subordinate entity of the hierarchy (i.e., increasing granularity). In either example, the chasing rule may be processed by traversing the hierarchy of the chasing rule in either direction (i.e., increasing or decreasing granularity).

In one or more embodiments, the Entitleable table (108) defines which tables (or data within the tables) are entitleable. Said another way, the Entitleable table (108) defines which of the tables and/or data within the tables users can access. For example, data not designated as entitleable may be accessible by all users or by no users depending on the desired behavior (i.e., default behavior to allow or deny access). In the case of no users having access, the data should be set as entitleable in order to provide access to data in the database.

In one or more embodiments, the Entitlement table (106) specifies data to which a user has access. In one or more embodiments, the data to which a user has access is defined using entries from the Entitlement table (106) in combination with entries in the Chasing Rules table (110). As such, the system does not require an administrator to specify access to data on a per-table basis; rather, the administrator can specify one or more chasing rules (as defined in the Chasing Rules table (110)) and grant a user access to all tables between (and including) the source table and target table. In one or more embodiments, the Entitlement table (106) also specifies one or more operations (e.g., select, insert, delete, update, etc.) that a user can perform on the data. In one or more embodiments, the Entitlement table (106) may specify a role and/or a group of users that have access to a given set of data within the database. In such cases, the Entitlement table (106) also includes entries specifying that a particular user is part of group and/or assigned a role.

In one or more embodiments, the entries from the Entitlement table (106) grant access to specific data entries in the tables associated with a chasing rule. For example, an entry in the Entitlement table (106) table may specify that a user has access to a particular data entry in a source table of a chasing rule. In this example, the chasing rule will further specify that the user also has access to target data entries in any target tables that are associated with the particular data entry in the source table.

In one or more embodiments, the user interface (114) includes functionality to receive queries from a user, send the queries to the view, receive results from the view, and display the results of the query to the user. Those skilled in the art will appreciate that the user interface (114) may correspond to a component of a variety of software applications. In this case, each software application may include a user interface (114) for interacting with the view layer (112). Further, the view layer (112) may be configured to provide a common layer of abstraction used by all of the software applications to access the database (100).

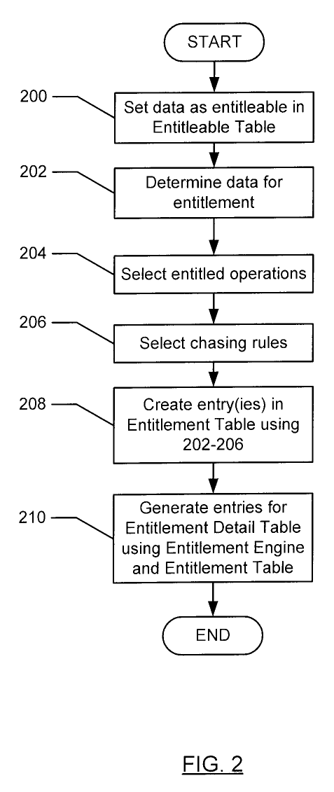

FIG. 2 shows method in accordance with one or more embodiments of hierarchical item level entitlement. In one or more embodiments, one or more of portions of the method shown in FIG. 2 may be omitted, repeated, and/or performed in a different order. Accordingly, embodiments should not be considered limited to the specific arrangement of the method shown in FIG. 2.

In Block 200, data (or table) is set as entitleable in the Entitleable table. In Block 202, one or more tables (or pieces of data) are selected to entitle. Said another way, a determination is made to allow user access to one or more tables (or pieces of data) in the database. In Block 204, one or more operations the user can perform on the one or more tables (or pieces of data) specified in Block 202 is determined. In Block 206, one or more chasing rules are selected. For example, a workflow may be selected, where the workflow is related to a number of chasing rules. In one or more embodiments, the chasing rules define how to traverse the tables in the hierarchy to reach the tables (or data) specified in Block 202. In one or more embodiments, if the appropriate chasing rule(s) does not exist in the Chasing Rules table, then Block 206 includes creating the necessary chasing rule(s).

In Block 208, one or more entries are created in the Entitlement table using the information specified in Steps 202-206. The entries in the Entitlement table may define the access rights of the user with respect to the chasing rules. In Block 210, one or more entries in the Entitlement Detail table are generated by the Entitlement Engine using the information in the Entitlement table and the Chasing Rules table. The entries in the Entitlement Detail table define the access rights of the user to data entries of tables described in the chasing rules. In one or more embodiments, the Entitlement Engine generates the aforementioned entries periodically and/or when requested by an administrator.

Those skilled in the art will appreciate that Block 210 may be repeated as additional data is added to the database. In this case, the user may not be required to configure the access rights of the additional data if a current entitlement and current chasing rule are applicable to the additional data. More specifically, additional entries in the Entitlement table may be generated using the current entitlement and the current chasing rule.

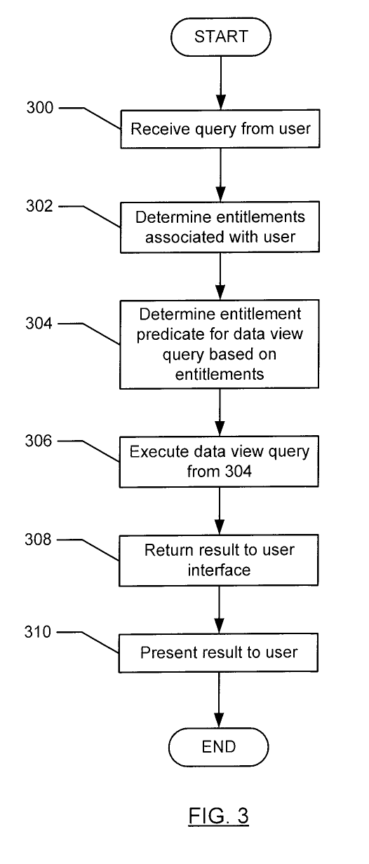

FIG. 3 shows method in accordance with one or more embodiments of hierarchical item level entitlement. In one or more embodiments, one or more of portions of the method shown in FIG. 3 may be omitted, repeated, and/or performed in a different order. Accordingly, embodiments should not be considered limited to the specific arrangement of the method shown in FIG. 3.

In Block 300, a request is received, by the view layer, from the user. In one or more embodiments, the request includes the identity of the user (i.e. user name) and a project (i.e. the location of the table(s) in the database to be accessed). In Block 302, the user identity and project are used to determine which entitlements are associated with the user in the current context. In one or more embodiments, the aforementioned determination is performed by querying the Entitlement Details table.

In Block 304, entitlement predicates are obtained for use in a data view query based on the determination made in Block 302. In one or more embodiments, the entitlement predicates are determined by a stored procedure, executing on a processor, using entries obtained from the Entitlement Details table. In Block 306, the data view query (with the entitlement predicates) is sent to the database and subsequently executed on the processor. In Block 308, the results of executing the data view query received in Block 306 are returned to the user interface via the view layer. In Block 310, the results of the data view query are presented to the user on the user interface. For example, the results may be presented in the user interface of a software application for review and/or modification by the user.

Those skilled in the art will appreciate that the determination of entitlement predicates for the data view query is abstracted from the user. In other words, the user (i.e., application) interacts with the data view as if the data view were a table, where the data view transparently manages the access rights to the underlying data. This abstraction ensures that the access rights of users are enforced for any number of applications accessing the database without requiring a specific implementation to handle access rights in each application.

The following is an example of one or more embodiments of hierarchical item level entitlement. The following example is not intended to limit the scope of hierarchical item level entitlement. Turning the example, consider a scenario in which the user (“Joe_User”) is to be granted access to select and update data associated with a Well, which has a primary identifier of 12345.

First, the Well is set as entitleable in an Entitleable table. The following is an example entry in the Entitleable table:

| Id | Entitleable | Data_Source_Name | Entity_Name | Entity_Version |
|---|---|---|---|---|
| 12345 | Well | Project 1 | Well | 5.0 |

Second, the following entries are created in the Entitlement table:

| Entitleable | | | | Chasing | Start | End |
|---|---|---|---|---|---|---|
| ID | Entitlee_Role_Name | Operation | Entitlee | Rule | Date | Date |
| 12345 | Data_Loader | Update | | Workflow 1 | Jan. 1, 2007 | Jun. 30, 2007 |
| 12345 | Data_Loader | Select | | Workflow 1 | Jan. 1, 2007 | Jun. 30, 2007 |
| <null> | Data_Loader | | Joe_User | | | |

Referring to the above entries in the Entitlement table, the first two entries entitle users associated with the Data_Loader role to update and select the data associated with the well (i.e., donated by 12345). The tables (in addition to the Well table) to which the Data_Loader roles have access is defined by workflow 1 (see below). The last entry associates Joe_User with the Data_Loader role.

As discussed above, the chasing rules are defined in a Chasing Rules table. The following are chasing rules (including workflow 1) in the Chasing Rule table:

| Workflow | Entity | Source | Target | Rank |
|---|---|---|---|---|
| 1 | Well | <Field | Well | 0 |
| 1 | Borehole | <Well | Borehole | 1 |
| 2 | Production_Entity | <Well | Production_Entity | 0 |
| 2 | Production_Header | <Production_Entity | Production_Header | 1 |
| 2 | Production_Volume | <Production_Header | Production_Volume | 2 |

The Chasing Rules table includes two workflows, namely, workflow 1 and workflow 2. Referring to workflow 1, the workflow starts at the Well table for a given Field (i.e., oilfield). The information in the Well table may then be used to identify boreholes associated with the Well, where the boreholes are listed in a Borehole table. In this example, Joe_User has access to one row in the Well table (i.e., the row for well 12345), and Borehole data associated with Well 12345 in the Borehole table. The chasing rules associated with a given workflow are evaluated in the order designated by the rank field starting from the lowest ranked entry associated with the workflow. Workflow 2 is evaluated in the same manner.

Continuing with the example, the entries in the Entitlement table and the Chasing Rules table evaluated by the Entitlement Engine to generate the following entries in an Entitlement Detail table:

| Data_Source_Name | Entitled_User | Entity_Name | Key_String | Operation |
|---|---|---|---|---|
| Project 1 | Joe_User | Well | 12345 | 0101 |
| Project 1 | Joe_User | Borehole | 11112 | 0101 |
| Project 1 | Joe_User | Borehole | 11113 | 0101 |
| Project 1 | Joe_User | Borehole | 11114 | 0101 |
| Project 1 | Joe_User | Borehole | 11115 | 0101 |

Referring to the above entries in the Entitlement Detail table, the Entitlement Engine, using the chasing rule (i.e., workflow 1) specified in the Entitlement table, traversed the hierarchy of tables in the database and determined that the Well is associated with four boreholes. Based on the chasing rules and the entries in the Entitlement table, Joe_User has access to data associated with Well 12345 and the four associated Boreholes 11112, 11113, 11114, and 11115.

In one or more embodiments, the operations a user may perform on the data are encoded using a bitmap. The following is an example of various operation bit maps: 1000=delete privilege; 0101=update and select privilege; 0010=insert privilege; and 1001=delete and select privilege. In this example, the use of a bitmap facilitates the extension of privileges (i.e., adding operations to be monitored) enforced by this scheme. Those skilled in the art will appreciate that other schemes may be used to denote which operations a user may perform on the data.

Continuing with the example, at some later point in time, the Joe_User attempts to access data in the Well table. However, as discussed above, Joe_User only has access to data associated with well 12345. In view of this, the view layer (using the Entitlement Detail table) appends the entitlement predicate to the query. In this example, the entitlement predicate is implemented using an Exists clause.

Example Query

```
CREATE OR REPLACE VIEW WELL
(INSERT_DATE, INSERT_USER, PRODUCED_BY, SDAT_LABEL, UPDATE_DATE,
UPDATE_USER, EXISTENCE_KIND, GUID, ID, VERSION,
NAME, ORIGINAL_SOURCE, REMARKS, SOURCE, ADDRESS_ID,
CURRENT_STATUS, CURRENT_STATUS_DATE, DRILL_SLOT_ID, DRILL_SLOT_NAME, FIELD_ID,
H2S_FLAG, LAHEE_CLASS, PERMANENT_COORD_SYSTEM_ID, SECURITY_CLASSIFICATION, SPUD_DATE,
STANDARD_PRESSURE, STANDARD_TEMPERATURE, SURFACE_LOCATION_ID, UWI)
AS
select a.Insert_Date,
  a.Insert_User,
  a.Produced_By,
  a.SDAT_Label,
  a.Update_Date,
  a.Update_User,
  a.Existence_Kind,
  a.GUID,
  a.Id,
  a.Version,
  a.Name,
  a.Original_Source,
  a.Remarks,
  a.Source,
  a.Address_Id,
  a.Current_Status,
  a.Current_Status_Date,
  a.Drill_Slot_Id,
  a.Drill_Slot_Name,
  a.Field_Id,
  a.H2S_Flag,
  a.Lahee_Class,
  a.Permanent_Coord_System_Id,
  a.Security_Classification,
  a.Spud_Date,
  a.Standard_Pressure * .1450377377302092222375207900063 as Standard_Pressure,
  (a.Standard_Temperature * 1.799999999999999856 + 31.9999999999999606664000000000031) as Standard_Temperature,
  a.Surface_Location_Id,
  a.UWI
from P20081.Well_{—} a
Where 1 = (case when BitAnd(a.Id, 127) <> 78 then 1
      else SDS_Sys.SDS_Public.Check_License(128)
    end)
  and exists (select 1
    from Entitlement_Detail b,
      Appl_User_Membership c
    where b.Key_String = a.Id
    and b.Data_Source_Account_Name = ‘P20081’
    and ( ( c.Appl_User_Name = User and c.Group_Type = ‘Role’ and c.Group_Name = b.Entitled_Role_Name)
      or ( c.Appl_user_Name = User and c.Group_Type = ‘Group’ and c.Group_Name = b.Entitled_User)
      or ( b.Entitled_User = User)
      )
    and Mod(b.operation_bitmap,10) = 1)
```

As discussed, the entitlements also specify which operations a user may perform on the data once the data has been retrieved. The operations which a user may perform are enforced by the view layer using entries in the Entitlement Detail table. The aforementioned functionality may be implemented using triggers. The following is an example of a trigger, which is used to determine whether Joe_User can update data in the Well table.

Example Trigger

```
CREATE OR REPLACE TRIGGER Well_UpI
instead of update on Well
for each row
declare
v_count INTEGER;
begin
-- check entitlement
select count(*) into v_Count
  from P20081.Well_{—} a
  where a.Id = :old.Id
  and exists (select 1
      from Entitlement_Detail b,
        Appl_User_Membership c
      where b.Key_String = :old.Id
      and b.Data_Source_Account_Name = ‘P20081’
      and (  ( c.Appl_User_Name = User and c.Group_Type = ‘Role’ and c.Group_Name = b.Entitled_Role_Name)
        or ( c.Appl_user_Name = User and c.Group_Type = ‘Group’ and c.Group_Name = b.Entitled_User)
        or ( b.Entitled_User = User)
        )
      and Mod(b.operation_bitmap,1000) >= 100);
if(v_Count = 0) then
  Raise_Application_Error(−20111, ‘Update failed. User is not entitled to update record.’);
end if;
-- update base table
update P20081.Well_{—}
  set Produced_By = :new.Produced_By,
  SDAT_Label = :new.SDAT_Label,
  Existence_Kind = nvl(:new.Existence_Kind,‘Actual’),
  GUID = :new.GUID,
  Version = nvl(:new.Version,‘1’),
  Name = :new.Name,
  Original_Source = :new.Original_Source,
  Remarks = :new.Remarks,
  Source = :new.Source,
  Address_Id = :new.Address_Id,
  Current_Status = :new.Current_Status,
  Current_Status_Date = :new.Current_Status_Date,
  Drill_Slot_Id = :new.Drill_Slot_Id,
  Drill_Slot_Name = :new.Drill_Slot_Name,
  Field_Id = :new.Field_Id,
  H2S_Flag = :new.H2S_Flag,
  Lahee_Class = :new.Lahee_Class,
  Permanent_Coord_System_Id = :new.Permanent_Coord_System_Id,
  Security_Classification = :new.Security_Classification,
  Spud_Date = :new.Spud_Date,
  Standard_Pressure = :new.Standard_Pressure / .1450377377302092222375207900063,
  Standard_Temperature = (:new.Standard_Temperature − 31.9999999999999606664000000000031) /
1.799999999999999856,
  Surface_Location_Id = :new.Surface_Location_Id,
  UWI = :new.UWI
  where Id = :old.Id;
end;
```

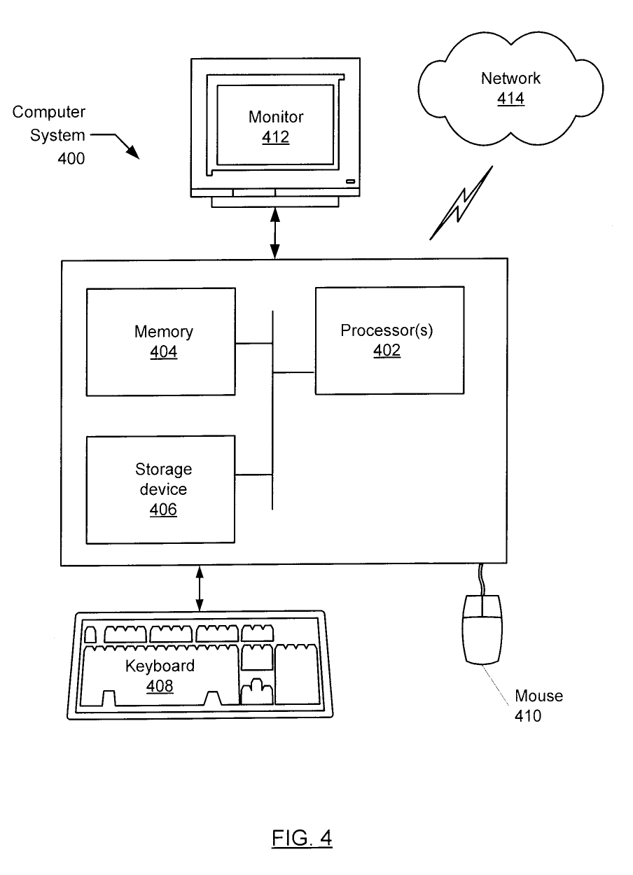

Embodiments of hierarchical item level entitlement may be implemented on virtually any type of computer regardless of the platform being used. For example, as shown in FIG. 4, a computer system (400) includes a processor (402), associated memory (404), a storage device (406), and numerous other elements and functionalities typical of today's computers (not shown). The computer (400) may also include input means, such as a keyboard (408) and a mouse (410), and output means (i.e., display device), such as a monitor (412). The computer system (400) may be connected to a network (414) (e.g., a local area network (LAN), a wide area network (WAN) such as the Internet, or any other similar type of network) via a network interface connection (not shown). Those skilled in the art will appreciate that these input and output means may take other forms.

Further, those skilled in the art will appreciate that one or more elements of the aforementioned computer system (400) may be located at a remote location and connected to the other elements over a network. Further, hierarchical item level entitlement may be implemented on a distributed system having a plurality of nodes, where each portion of the implementation may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform embodiments of hierarchical item level entitlement may be stored on a computer readable medium such as a compact disc (CD), a diskette, a tape, a file, or any other computer readable storage device.

While hierarchical item level entitlement has been described with respect to a limited number of embodiments, those skilled in the art, having benefit of this disclosure, will appreciate that other embodiments can be devised which do not depart from the scope of hierarchical item level entitlement as disclosed herein. Accordingly, the scope of hierarchical item level entitlement should be limited only by the attached claims.

What is claimed is:

1. A method for retrieving data from a database comprising:
receiving a query for the data in the database;
determining a user associated with the query;
obtaining an entitlement entry associated with the user, the entitlement entry created by applying an entitlement rule associated with the user to a chasing rule;
determining, using a processor, an entitlement predicate for a data view query using the entitlement entry, the data view query comprising the entitlement predicate and associated with the query;
executing, on the processor, the data view query to obtain the data in the database, the user being entitled to view the data; and
presenting the data to the user.

2. The method of claim 1, wherein the entitlement rule defines a row in a table to which the user has access.

3. The method of claim 2, wherein the entitlement rule further defines an operation the user may perform on data in the row.

4. The method of claim 3, wherein the operation is one selected from a group consisting of select, update, delete, and insert.

5. The method of claim 1, wherein the chasing rule defines a hierarchy of tables in the database, wherein the table is in the hierarchy of tables.

6. The method of claim 5, wherein the chasing rule further defines an order in which the hierarchy of tables is traversed.

7. The method of claim 1, wherein the entitlement entry is obtained from an Entitlement Detail table, wherein the Entitlement Detail table is populated with the entitlement entry by an Entitlement Engine.

8. The method of claim 1, wherein the data is associated with an entry in an Entitleable table that specifies the data can be entitled.

9. A computer readable medium, embodying instructions executable by a computer to perform a method for retrieving data from a database, the instructions comprising functionality for:
receiving a query for the data;
determining a user associated with the query;
obtaining an entitlement entry associated with the user;
determining an entitlement predicate for a data view query using the entitlement entry, the data view query comprising the entitlement predicate and associated with the query;
executing the data view query to obtain the data, the user being entitled to view the data; and
presenting the data to the user.

10. The computer readable medium of claim 9, wherein the entitlement entry is created by applying an entitlement rule associated with the user to a chasing rule.

11. The computer readable medium of claim 10, wherein the entitlement rule defines a row in a table to which the user has access.

12. The computer readable medium of claim 11, wherein the entitlement rule further defines an operation the user may perform on data in the row.

13. The computer readable medium of claim 12, wherein the operation is one selected from a group consisting of select, update, delete, and insert.

14. The computer readable medium of claim 10, wherein the chasing rule defines a hierarchy of tables in the database, wherein the table is in the hierarchy of tables.

15. The computer readable medium of claim 14, wherein the chasing rule further defines an order in which the hierarchy of tables is traversed.

16. The computer readable medium of claim 9, wherein the entitlement entry is obtained from an Entitlement Detail table, wherein the Entitlement Detail table is populated with the entitlement by an Entitlement Engine.

17. The computer readable medium of claim 9, wherein the data is associated with an entry in an Entitleable table that specifies the data can be entitled.

18. A system for retrieving data from a database comprising:
a view layer embodied as instructions executing on a processor and configured to:
receive a query for the data;
determine a user associated with the query;
obtain an entitlement entry associated with the user;
determine an entitlement predicate for a data view query using the entitlement entry, the data view query comprising the entitlement predicate and associated with the query;
execute the data view query to obtain the data, the user being entitled to view the data;
a storage device configured to store the entitlement entry; and
a display device configured to present the data to the user.

19. The system of claim 18 further comprising:
an entitlement engine configured to create the entitlement entry by applying an entitlement rule associated with the user to a chasing rule;

20. The system of claim 19, wherein the entitlement rule defines a row in a table to which the user has access, wherein the chasing rule defines a hierarchy of tables, including the table, in the database.
